(19) United States
(12) Patent Application Publication
(10) Pub. No.: US 2025/0257484 A1
(43) Pub. Date: Aug. 14, 2025

(54) AN ELECTRODE FOR OXYGEN GENERATION

(71) Applicant: OÜ Stargate Hydrogen Solutions, Tallinn (EE)

(72) Inventor: Rainer KÜNGAS, Tallinn (EE)

(21) Appl. No.: 18/857,384

(22) PCT Filed: Apr. 17, 2023
(86) PCT No.: PCT/EP2023/059941

§ 371 Date: Oct. 16, 2024

(30) Foreign Application Priority Data
Apr. 18, 2022 (EP) 22168697.5

(51) Int. Cl. C25B 11/077; C25B 1/04; C25B 9/73; C25B 11/037; C25B 11/061

(52) U.S. Cl. CPC C25B 11/0773; C25B 1/04; C25B 9/73; C25B 11/037; C25B 11/061

(57) ABSTRACT

An electrode suitable for carrying out oxygen evolution reaction in the electrolysis of water in alkaline conditions. The electrode includes a ceramic material having a stability factor (SF) between 1.67≤SF≤2.8 and which is calculated by formula (II), where r_{O} is the ionic radius of oxide ion (O²⁻), r_{B,av} is the weighted average ionic radius of a transition metal, n_{A,Av} is the weighted average oxidation state of a rare earth or alkaline earth metal, r_{A,av} is the weighted average ionic radius of a rare earth or alkaline earth metal. An alkaline electrolysis stack includes the electrode, as well as a method for the electrolysis of water in alkaline conditions using the alkaline electrolysis stack.

### TECHNICAL FIELD

The present invention relates to an electrode for use in electrolysis, in particular, an electrode for use in oxygen generation which is suitably used in the electrolysis of water in alkaline conditions, and which exhibits a low overpotential towards oxygen evolution reaction. The invention relates further to an alkaline electrolysis stack comprising at least one such electrode, as well as a method for the electrolysis of water in alkaline conditions using the alkaline electrolysis stack.

### BACKGROUND ART

In alkaline water electrolysis, water is electrochemically converted into hydrogen and oxygen in alkaline conditions: H₂O=H₂+0.5O₂. An electrolysis cell comprises two electrodes: an anode and a cathode. During operation, an electric potential is applied between the two electrodes, resulting in the flow of electrolysis current through the electrolysis cell. During operation, hydrogen is generated on the cathode according to the hydrogen evolution reaction (HER): 2H₂O+2e⁻=H₂+2OH⁻, while oxygen is generated on the anode according to the oxygen evolution reaction (OER): 2OH⁻=0.5O₂+H₂O+2e⁻. An alkaline electrolysis cell also comprises an electrolyte, which comprises a liquid alkaline medium such as an aqueous solution of hydroxides and/or carbonates. The electrolysis cell further comprises a porous separator and/or an ion exchange membrane capable of conducting hydroxide ions.

In alkaline water electrolysis, it is desirable to simultaneously minimize the investment cost and the energy consumption of the electrolysis cell. All else being equal, the lower the investment cost and the lower the energy consumption of the cell, the lower the production costs of hydrogen produced via electrolysis. The investment cost of the electrolysis cell is minimized when low-cost materials are used in the electrolysis cell and when such cells are produced using low-cost production methods. The energy consumption of the electrolysis cell is minimized when, for a fixed operating current or current density, the required applied electric potential (voltage) is minimized. The required applied electric potential is a sum of several contributions and comprises: 1) the theoretical electric potential required to carry out the electrochemical reactions, 2) a potential due to the porous separator and/or ion exchange membrane, 3) an overpotential due to the anode, 4) an overpotential due to the cathode, 5) a potential that is dependent on the distance between the anode and the cathode in the electrolysis cell. Here, the term ‘overpotential’ refers to the difference between the theoretical and actual applied potential to each electrode, and includes the potential contribution due to e.g., bubble formation. It is known to those skilled in the arts that the overpotential of the anode (i.e., of the OER) is generally higher than the overpotential of the cathode (i.e., of the HER). Therefore, the development of improved electrodes for oxygen generation is highly relevant. In particular, such electrodes should comprise low-cost materials and be produced using low-cost fabrication methods, while exhibiting lower overpotentials towards OER than state-of-the-art electrodes.

In industrial alkaline electrolysis cells, OER electrodes are either based on nickel or precious metals. Nickel-based electrodes are relatively low-cost, but are characterized by high overpotentials, resulting in high energy consumption of the cell, and, in turn, high production cost of hydrogen. In contrast, electrodes based on precious metals or their compounds (such as IrO₂, RuO₂, Pt) result in low overpotentials, but are very high in investment costs, resulting in high production cost of hydrogen. A third class of alkaline electrolysis OER electrode material has been discovered, which has been shown to exhibit low overpotentials while simultaneously being low-cost.

Specifically, ceramic materials with specific crystal structures, such as the perovskite structure, have been shown to be a particularly attractive alternative to both nickel- and precious metal-based OER electrodes.

Examples of such ceramic materials are described in Wo 2013/012965 A1, MASSACHUSETTS INST TECHNOLOGY [US], 24.01.2013. An OER catalyst with a formula AₓA′₁₋ₓB_{y}B′_{1-y}O_{3+δ} is provided, where each of A and A′, independently, is a rare earth or alkaline earth metal, x is in the range of 0 to 1, each of B and B′, independently, is a transition metal, y is in the rate of 0 to 1, and δ is in the range of 0 to 1. Example materials described in the referenced application include LaCrO₃, LaMnO₃, LaFeO₃, LaCoO₃, LaNiO₃, LaNi_{0.5}Mn_{0.5}O₃, LaCu_{0.5}Mn_{0.5}O₃, La_{0.5}Ca_{0.5}MnO_{3-δ}, La_{0.5}Ca_{0.5}FeO_{3-δ}, La_{0.75}Ca_{0.25}FeO_{3-δ}, La_{0.5}Ca_{0.5}CoO_{3-δ}, LaMnO_{3-δ} and Ba_{0.5}Sr_{0.5}Co_{0.8}Fe_{0.2}O_{3-δ}. The number of materials that can be described using the above formula is in practice limitless, and some materials, despite having a composition described as AₓA′₁₋ₓB_{y}B′_{1-y}O_{3+δ}, are less suitable for use in alkaline electrolysis cells than others. While the entirety of the formula AₓA′₁₋ₓB_{y}B′_{1-y}O_{3+δ} is claimed, materials wherein the occupancy of the o-bonding orbital of e_{g} symmetric parentage of B, B′, or each of B and B′, is within a specific range, are claimed to result in high OER activity. More specifically, Ba_{0.5}Sr_{0.5}Co_{0.8}Fe_{0.2}O_{3-δ} was found to exhibit particularly high OER activity: an OER current of 100 mA/cm² at an electrode overpotential of 0.4 V in 0.1 M KOH, compared to 18 mA/cm² for IrO₂ and 5 mA/cm² for RuO₂ electrodes under identical conditions.

The main problem with the approach proposed in WO 2013/012965 A1 is the insufficient stability of the claimed materials under conditions used in industrial alkaline water electrolysis cells. The authors of WO 2013/012965 A1 have subsequently shown that under OER in 0.1 M KOH solution, the most electrocatalytically active of the proposed materials, notably Ba_{0.5}Sr_{0.5}Co_{0.8}Fe_{0.2}O_{3-δ} and SrCo_{0.8}Fe_{0.2}O_{3-δ} lost their crystal structure, while some other materials, notably LaCoO₃, did not (Risch et al., J. Phys. Chem. C, 117 (2013) 8628). Generally, the loss of crystal structure or selective leaching of elements from the material is correlated with lower OER activity (i.e., higher overpotential).

US 2016/0289850 A1, DE NORA TECH INC [US], 6.10.2016 describes the conditions used in industrial alkaline water electrolysis cells: an alkaline electrolyte of 5-30 weight % KOH or NaOH (for example, 25 weight % KOH), pre-heated to 80° C. The industrial conditions are therefore much more challenging from a material stability point of view compared to 1 M KOH solution at room temperature. It is desirable to operate industrial alkaline water electrolysis cells at elevated temperatures (e.g., 80° C.) and to use concentrated alkaline solutions (e.g., 25 weight % KOH) in order to lower required applied electric potential. The use of elevated temperatures and high alkali concentrations affects positively not only the anode potential, but also the potential due to the porous separator and/or ion exchange membrane (the conductivity of the separator and/or membrane increases), the overpotential due to the cathode, the potential that is dependent on the distance between the anode and the cathode (the conductivity of the electrolyte increases, resulting in a lower ohmic drop). Therefore, while operating at lower temperatures and less concentrated alkali solutions may, due to stability reasons, be desirable from the perspective of the anode as described in WO 2013/012965 A1, the enhanced performance of the anode will generally not compensate for the performance penalty that the lower temperature and alkali concentration causes in other electrolysis cell components.

Therefore, there is still a need for identifying new ceramic materials which would simultaneously be low-cost, result in low OER overpotentials, and be stable under industrially relevant conditions (i.e., elevated temperature, concentrated alkali solutions).

### DISCLOSURE OF INVENTION

The inventor, having a desire to produce low-cost hydrogen via alkaline water electrolysis, has found that the anodes based on ceramic materials described in prior art still have drawbacks. More specifically, the anodes that initially demonstrate lowest OER overpotentials, such as anodes comprising Ba_{0.5}Sr_{0.5}Co_{0.8}Fe_{0.2}O_{3-δ}, deactivate quickly under industrially relevant electrolysis conditions due to insufficient phase stability. On the other hand, the anodes that do not deactivate under industrially relevant electrolysis conditions commonly also demonstrate prohibitively high OER overpotentials. Presently, the search for anode materials that do not deactivate, yet demonstrate low OER overpotentials, is largely based on intuition and trial-and-error approach.

The inventor has found out that a parameter, herein referred to as “stability factor” and abbreviated as SF can successfully predict the phase stability of ceramic materials suitable for alkaline electrolyzer anodes. More specifically, based on the value of SF, the stability of certain ceramic materials in strongly alkaline solutions and their activity towards OER (the activity being inversely proportional to overpotential) can be estimated. This, in turn, makes it possible to distinguish between a) materials that are active, but not phase-stable, b) materials that are phase-stable, but inactive, and c) materials that are simultaneously active and phase-stable. Materials that are active, but not phase-stable have relatively high SF values, while materials that are phase-stable but inactive have relatively low SF values. Materials with intermediate SF values exhibit simultaneously sufficient electrochemical activity (i.e., low electrode overpotentials towards OER) as well as sufficient phase stability.

According to an aspect of the present invention an electrode is provided for carrying out oxygen evolution reaction in the electrolysis of water in alkaline conditions, the electrode comprising a ceramic material [(Aₓ)A′₍₁₋ₓ₎]_{y}B_{z}B′_{(1-z)}O_{3-δ}, wherein each of A and A′, independently, is a rare earth or alkaline earth metal, x is in the range of 0 to 1, y is A-site occupancy and is in the range of 0.5 to 0.99, each of B and B′, independently, is a transition metal, z is in the range of 0 to 1, O is oxygen, and d is oxygen non-stoichiometry and is in the range of −1 to 1, and wherein SF of the ceramic material is larger than or equal to 1.67 and smaller than or equal to 2.8. In the context of this invention, “stability factor” or “SE” refers to a parameter that is defined as

$$SF = \frac{{r}_{O} \cdot \frac{3 - δ}{3}}{{r}_{B , av}} - {n}_{A , Av} [ {n}_{A , Av} - \frac{{r}_{A , av} / {r}_{B , av}}{ln ( \frac{{r}_{A , av}}{{r}_{B , av}} )} ]$$

where rₒ is the ionic radius of oxide ion (O²⁻), r_{B,av} is the weighted average ionic radius of B and B′, N_{A,Av} is the weighted average oxidation state of A and A′, and r_{A,av} is the weighted average ionic radius of A and A′.

The terms “phase stability” and “phase-stable” are meant to refer to the property of a material to retain its crystallographic phase upon exposure to industrially relevant alkaline water electrolysis conditions. One way to evaluate the phase stability of a material or to evaluate whether a material is phase stable is to acquire X-ray diffractograms of the material before and after exposure to industrially relevant alkaline water electrolysis conditions. Phase stability is confirmed in case there are no significant differences in the corresponding X-ray diffractograms, i.e., in case no phase changes in the bulk of the material have taken place. In the context of the present invention, “industrially relevant alkaline water electrolysis conditions” refer to exposure to aqueous solutions of potassium hydroxide that contain more than 20 weight percent of KOH (20 weight % KOH) at a temperature of 75-85 degrees Celsius, with or without applied electrolysis current. In order to verify phase stability, the exposure time to the aforementioned conditions should be at least 24 hours, and preferably at least 100 hours. Alternative methods for determining phase stability exist, but it is important to note that highly surface-sensitive methods such as X-ray photoelectron spectroscopy or low-energy ion scattering are, in the context of the present invention, not suitable methods for determining phase stability due to the failure of these methods to probe the bulk of the material.

The term “A-site occupancy”, denoted as “y” in formulas and equations of the present invention, is meant to refer to the number of A-site cations relative to the number of B-site cations in the ceramic material. For example, for Ba_{0.5}Sr_{0.5}Co_{0.8}Fe_{0.2}O_{3-δ} (which can also be written as [Ba_{0.5}Sr_{0.5}]_{1.0}Co_{0.8}Fe_{0.2}O_{3-δ}, y=1.0. In La_{0.95}CoO₃ (equivalent to [La_{1.0}]_{0.95}CoO₃), Y=0.95. Note that for the purposes of estimating A-site occupancy, the occupancy of the B-site is taken to be equal to unity. For example, to calculate the A-site occupancy of LaCo_{1.05}O_{3.16}, the material composition is expressed in such a way that the sub-index of the B-site cation (i.e., Co) is equal to unity, resulting in La_{0.95}CoO₃ and hence y=0.95.

The terms “A-site” and “B-site” are meant to refer to energetically distinct sites in the crystallographic lattice of ceramic the material. Note that although the formula [(Aₓ)A′₍₁₋ₓ₎]_{y}B_{z}B′_{(1-z)}O_{3-δ} generally refers to a material with a perovskite structure (ABO₃) or a double perovskite structure (A₂B₂O₅), in the context of the present invention, the terms “A-site” and “B-site” are used more broadly and are independent of the crystal structure of the ceramic material.

The term “oxygen non-stochiometry”, denoted as “d” in formulas and equations of the present invention, is meant to refer to the number of oxygen vacancies relative to the number of B-site material. the ceramic For example, for cations in La_{0.90}Ni_{0.6}Fe_{0.4}O_{2.85} (equivalent to La_{0.90}Ni_{0.6}Fe_{0.4}O_{3-0.15}), δ=0.15. In oxygen excess compounds, δ has negative values: for example, in La_{0.3}Sr_{0.7}TiO_{3.15} (equivalent to La_{0.3}Sr_{0.7}TiO_{3+0.15}), δ=−0.15. Note that any double perovskite A₂B₂O_{5+δ′} can be expressed as ABO₃-& by acknowledging that 8′=1-28. Oxygen non-stoichiometry is dependent on e.g., temperature, oxygen partial pressure, and applied voltage.

The term “ionic radius” is meant to refer to Shannon ionic radius, as defined in R. D. Shannon, Acta Crystallogr. A, 32 (1976) 751-767. For example, the ionic radius of the oxide anion, O²⁻, with a coordination number of 2 is thereby 1.35 Å. In the context of the present invention, the term “weighted average ionic radius of A and A′” of a ceramic material with a formula [(Aₓ)A′₍₁₋ₓ₎]_{y}B₂B′_{(1-z)}O_{3-δ} is meant to refer to the weighted average of the Shannon ionic radii of cations A and A′, where the weights are x for the ionic radius of A and (1-x) for the ionic radius of A′, and where the resulting radius is multiplied by the A-site occupancy, y. In other words,

$${r}_{A , Av} = [ x \cdot {r}_{A} + ( 1 - x ) \cdot {r}_{{A}^{′}} ] \cdot y ,$$

where r_{A} is the ionic radius of A and r_{A′} is the ionic radius of A′. By analogy,

$${r}_{B , Av} = z \cdot {r}_{B} + ( 1 - z ) \cdot {r}_{{B}^{′}} .$$

The term “weighted average oxidation state of A and A′” of a ceramic material with a formula [(Aₓ)A′₍₁₋ₓ₎]_{y}B_{z}B′_{(1-z)}O_{3-δ} is meant to refer to the weighted average of the oxidation state of cations A and A′, where the weights are x for the oxidation state of A and (1-x) for the oxidation state of A′, multiplied by the A-site occupancy, y. In other words,

$${n}_{A , Av} = [ x \cdot {n}_{A} + ( 1 - x ) \cdot {n}_{{A}^{′}} ] \cdot y ,$$

where n_{A} is the oxidation state of A and n_{A′} is the oxidation state of A′.

The term “alkaline electrolysis stack” is meant to refer to a device comprising more than one alkaline electrolysis cell connected electrically in series. The higher the number of cells in the stack, the more hydrogen and oxygen can be produced in unit time. Similarly, the larger the surface area (foot print) of each cell in the stack, the more hydrogen and oxygen can be produced. The electrodes in the electrolysis cells of the electrolysis stack are separated either by a porous separator (such as Zirfon) and/or an ion exchange membrane capable of conducting hydroxide ions.

The above embodiment of the invention is associated with several important advantages compared to state-of-the-art. Firstly, electrodes of the invention are characterized by sufficient phase-stability, which in turn means that the electrodes do not need to be frequently replaced during operation. Secondly, the electrodes of the invention are sufficiently active, enabling low overpotentials, high efficiencies and thereby low hydrogen production costs. Thirdly, the electrodes of the invention are free of precious metals such as iridium, platinum and ruthenium, which alleviates the issue related to the availability of electrode materials, as well as decreases electrode raw material costs considerably. Fourthly, the electrodes of the invention have lower overpotentials towards the oxygen evolution reaction than conventional nickel-based electrodes. Since electricity costs are a major factor determining the production costs of hydrogen produced by electrolysis, the electrodes of the invention thereby enable hydrogen to be produced at lower costs (OPEX) than conventional nickel-based electrodes.

EP 3 587 622 A1, ASAHI KASEI KABUSHIKI KAISHA [JP], 01.01.2020, describes an anode for water electrolysis comprising a porous substrate, a metal oxide layer containing at least a perovskite-structured metal oxide on or above a part of a surface of or an entire surface of the porous nickel substrate, wherein a content of the perovskite-structured metal oxide in a crystalline constituent in the metal oxide layer is 90% or more and 100% or less. EP 3 587 622 A1 further describes an anode, wherein the perovskite-structured metal oxide is a metal oxide having a composition represented by AₓA′₍₁₋ₓ₎Ni_{y}B′_{(1-y)}O_{3-z}, where each of A and A′ is an alkali earth metal or rate earth element, B′ is one of Cr, Mn, Fe, Co, and Cu, x satisfies 0<x<1, y satisfies 0≤y≤1, and z satisfies 0≤z≤1. EP 3 587 622 A1 reports overvoltage values after 100 hours or total operation at 6 kA/m² and confirms the inferior performance (most likely due to inferior phase-stability) of Ba_{0.5}Sr_{0.5}Co_{0.8}FeO₃ compared to LaNiO₃. The SF value for Ba_{0.5}Sr_{0.5}Co_{0.8}FeO₃ is 3.91, while the SF value of LaNiO₃ is 1.62. In other words, Ba_{0.5}Sr_{0.5}Co_{0.8}FeO₃ is not phase-stable enough for long-term stability under industrially relevant conditions, whereas LaNiO₃ is too inactive towards OER, and the related overpotential can advantageously be further decreased, e.g., by incorporating A-site occupancy of 0.5≤y≤0.99. Furthermore, the method of applying the perovskite onto the surface of the nickel substrate is highly labour intensive, requiring 13 application and drying cycles, followed by a calcination cycle.

A publication by Ma et al. in Journal of Alloy and Compounds, 854 (2021) 157154, discloses a series of perovskite oxides: La_{0.95}FeO₃, La_{0.95}Fe_{0.9}Co_{0.1}O₃, La_{0.95}Fe_{0.8}Co_{0.2}O₃, La_{0.95}Fe_{0.7}Co_{0.3}O₃, and La_{0.95}Fe_{0.6}Co_{0.4}O₃. Of these five materials, Ma et al. then disregard La_{0.95}FeO₃ and La_{0.95}Fe_{0.6}Co_{0.4}O₃ without further explanation and focus on three remaining materials: La_{0.95}Fe_{0.9}Co_{0.1}O₃, La_{0.95}Fe_{0.8}Co_{0.2}O₃, La_{0.95}Fe_{0.7}Co_{0.3}O₃. The authors then subject the three materials to a reduction procedure in order to induce exsolution of Co or Co/Fe nanoparticles, and then evaluate the performance of the resulting materials for OER. Importantly, during the reduction procedure, the composition of the original materials inevitably changes. For example, La_{0.95}Fe_{0.9}Co_{0.1}O₃ becomes a mixture of LaFe_{0.9}Co_{0.1}O₃ (0.95 mol for every mole of La_{0.95}Fe_{0.9}Co_{0.1}O₃) and Fe_{0.9}Co_{0.1} (0.05 mol for every mole of La_{0.95}Fe_{0.9}Co_{0.1}O₃). In all cases, the resulting materials are no longer A-site deficient. The stability factor of LaFe_{0.9}Co_{0.1}O₃, La_{0.95}Fe_{0.8}Co_{0.2}O₃, and La_{0.95}Fe_{0.7}Co_{0.3}O₃ is calculated to be 1.65, 1.65, and 1.66, respectively. The present invention differs from the publication as the materials in present invention do not undergo any reduction procedures that alter A-site deficiency of the materials.

A publication by Poznyak et al. in Journal of Solid State Electrochemistry 12 (2008) 15-30 discloses inter alia a series of perovskite materials: La_{0.3}Sr_{0.7}CoO_{2.924}, La_{0.3}Sr_{0.7}Co_{0.8}Al_{0.2}O_{2.85}, (La_{0.3}Sr_{0.7})_{0.97}CoO_{2.896}, La_{0.5}Sr_{0.5}CoO₃, La_{0.55}Sr_{0.45}CoO₃, La_{0.65}Sr_{0.35}CoO₃, La_{0.7}Sr_{0.3}CoO₃, La₂NiO_{4.15}, La₂Ni_{0.9}Co_{0.1}O_{4.169}, La₂Ni_{0.8}Cu_{0.2}O_{4.124}. Although some of these materials have the perovskite structure, one material has A-site occupancy less than 1 and some materials have a SF below 2.8, not a single material in the publication simultaneously satisfies all three conditions. Hence the present invention is differentiable over the prior-art reference.

According to an aspect of the present invention the electrode also comprises a second material, this second material being metallic Ni, a metallic alloy of Fe and Ni, or a hydroxide of Ni and Fe. An advantage of combining the ceramic material with a second, rather conventional electrode material is that the second material can provide part of the electrochemical activity of the combined electrode. This is particularly important in situations where the electrode is partially poisoned by impurities: if the electrode is made of more than one material, the affinity of these materials towards different impurity species is different, i.e., the extent by which they are affected by impurity adsorption is different. As a result, an electrode comprising more than one material is generally more stable and robust than an electrode comprising a single material. Note that the composition of the second material can refer to either the composition of the material before or after exposure to operating conditions. For example, it is well-known that Fe impurities in the electrolyte can the electrodes during operation.

EP 3 444 383 B1, DE NORA PERMELEC LTD [JP], 20.02.2019, describes an anode for alkaline water electrolysis comprising a conductive substrate having at least a surface composed of nickel or a nickel-based alloy, and an electrode catalyst layer formed on the surface of the conductive substrate, wherein a catalyst component that constitutes the electrode catalyst layer comprises: a first catalyst component having a nickel-cobalt spinel oxide represented by a structural formula NiCo₂O₄, or a lanthanide-nickel-cobalt perovskite oxide represented by a structural formula XNiₐCO₁₋ₐO₃ (wherein X represents at least one metal selected from among lanthanides including lanthanum, cerium and praseodymium, and 0<a<1), and a second catalyst component having at least one of iridium oxide and ruthenium oxide, wherein an amount of the second catalyst component, calculated as an amount of a component metal, is at least 0.2 g/m². The perovskite materials described in EP 3 444 383 B1 generally exhibit very low SF values. For example, for all compositions of LaNiₐCO₁₋ₐO₃, SF<1.67: e.g., LaNi_{0.1}Co_{0.9}O₃ (SF=1.66), LaNi_{0.5}Co_{0.5}O₃ (SF=1.64), LaNi_{0.9}Co_{0.1}O₃ (SF=1.63). In other words, the materials chosen here are not optimal for OER: they are “too stable” and more active materials could be obtained by e.g., introducing A-site occupancy in the range from 0.5 to 0.99. Furthermore, the electrode described in EP 3 444 383 B1 still contains significant amounts of iridium and ruthenium oxide to achieve required activity levels. The use of iridium and ruthenium is problematic not only due to the high cost of these elements, but also due to the very limited availability of these elements in the Earth's crust.

In an embodiment according to the present invention, the ceramic material is uniformly dispersed on the surface of the second material. The term “X is uniformly dispersed on the surface of Y” is meant to refer to a situation where the concentration of the particles of X on the surface of Y is the same, no matter which part of the surface of Y is inspected, provided the area of inspection is sufficiently large. “X” refers to, for example, the ceramic material, “Y” refers to, for example, to the second material. In the context of the present invention, the area of inspection is considered sufficiently large, if the area of inspection includes at least 500 particles of X, as identified by e.g., electron microscopy. An advantage of dispersing the ceramic material on the surface of the second material is that an electrode with a uniform electrochemical activity is obtained. Furthermore, since electrochemical reactions on the surface of electrode materials are associated with significant reaction enthalpies, uniform dispersion of the ceramic material helps to avoid “hot spots” (local temperature gradients) in the electrode, which might damage the electrode structure or the separator/membrane.

According to an aspect of the present invention, the particles of the ceramic material are immobilized and partly encapsulated by the second material. In the context of the present invention, the term “X is immobilized” is meant to refer to a situation where the particles of X are unable to detach and move around during electrolyzer operation. Furthermore, the term “X is partly encapsulated by Y” is meant to refer to a situation where the particles of X are in contact with Y from more than one side (partial encapsulation), but not from all sides (complete encapsulation). An advantage of this aspect of the invention is that the ceramic materials are locked strongly in place during operation, thereby avoiding situations where e.g., ceramic particles fall to the bottom of the electrolysis stack due to gravity and cause non-uniform electrode activity or mechanical issues. Partial encapsulation is a particularly effective way of dispersing ceramic material on the surface of the second material, since it ensures that the ceramic material is strongly attached to the surface of the second material, while still being exposed to the electrolyte and thus remaining electrochemically active.

According to an aspect of the present invention, A is an element from the following list of elements: La (lanthanum), Ce (cerium), Gd (gadolinium), Pr (praseodymium), Ba (barium); and A′ is an element from the following list of elements: Sr (strontium), Ca (calcium), Ba (barium), Ce (cerium); and B or B′, independently, is an element from the following list of elements: Mn (manganese), Ni (nickel), Fe (iron), Co (cobalt), Ti (titanium), Cr (chromium). The advantage of using La, Ce, Gd, Pr, or Ba as A is related to the combination of suitable cation size for La³⁺, Ce³⁺, Gd³⁺, Pr³⁺ and Ba²⁺ in the perovskite lattice, and the availability (price) of these elements. For example, Dy³⁺ and Eu³⁺ would also be suitable from ionic radius point of view, but are too expensive for wide-scale use. An advantage of using Sr, Ca, Ba or Ce as A′ is that such elements generally increase the electrical conductivity, as well as oxygen vacancy concentration of the ceramic material. The advantages of using Mn, Ni, Fe, Co, Ti, Cr as B or B′ are two-fold: first, the use of transition metals improves the electronic conductivity of the materials due to the many possible oxidation states of the metals, enabling for example the polaron hopping conduction mechanism. Secondly, the use of Mn, Ni, Fe, Co, Ti, or Cr as B or B′ over metals such as Ru or Ir as B or B′ is advantageous due to the lower cost of Mn, Ni, Fe, Co, Ti, or Cr compared to Ru and Ir.

In an embodiment according to the present invention, A-site occupancy, denoted as y, is in the range of 0.6 to 0.98, and preferably in the range of 0.75 and 0.98. A-site occupancy values below unity (e.g. 0.9) are advantageous, since this results in A-site cations being more strongly bound to the crystal structure. However, when A-site occupancy values are too low (e.g. below 0.6), some of the B-site cations risk no longer being incorporated into the structure of the ceramic material, resulting in some of the B cations forming secondary oxide phases. Best results are obtained when A-site occupancy is within a certain range, such as between 0.6 and 0.98, and preferably between 0.75 and 0.98.

In an embodiment according to the present invention, the average particle size of the ceramic material is between 10 nm and 300 nm and preferably between 20 nm and 200 nm. Generally, the electrochemical and catalytic activity of a material increases when the specific surface area of the material increases. Therefore, it is desirable to maximize the surface area of the ceramic material, i.e., to decrease the average particle size of the material. However, once the particle size becomes too small, for example below 20 nm, material properties begin to change due to a larger fraction of material atoms now occupying edge and corner sites in the particles. This latter phenomenon not only affects the electrochemical activity of the material, but also influences the stability of the material, generally leading to decreased stability. It is therefore desirable that the average particle size of the ceramic material is within an optimal range, such as between 10 nm and 300 nm or between 20 nm and 200 nm.

According to an aspect of the present invention, the ceramic material has a perovskite crystal structure. The perovskite structure is advantageous, since it is a very versatile material class and generally more stable (e.g. less susceptible to A-site cation leaching) for than, example, the corresponding Ruddlesden-Popper phases. Perovskites are generally more electrochemically active than the corresponding spinel phases.

In an embodiment according to the present invention, the electrode overpotential towards oxygen evolution reaction is less than or equal to 400 millivolts at a current density of 1 mA/cm², when the oxygen evolution reaction is carried out using a rotating disk electrode at a rotation rate of 1500 rpm in 20-35% KOH and at a temperature of 75-85 degrees Celsius. The electrode of the invention is optimized for use under industrial alkaline electrolysis conditions, i.e., in 20-35% KOH and at a temperature range between 75° C. and 85° C. It is desirable to minimize the electrode overpotential towards oxygen evolution reaction, and at an electrolysis current density of 1 mA/cm², the overpotential should be less than or equal to 400 mV in order to be at least on par with the performance of state-of-the-art iridium-based electrodes. In a typical rotating disk electrode experiment, the ceramic material is deposited onto the surface of an electrode (e.g., glassy carbon electrode) and immersed into the KOH solution. Electrode performance (overvoltage at different current densities) can then be evaluated at a range of electrode rotation rates to study the effects of kinetic versus mass transport limitations. Ohmic drops can be corrected by additionally carrying out electrochemical impedance spectroscopy measurements.

In an embodiment according to the present invention, the ceramic material is phase-stable for 100 hours in 6 M KOH at 80 degrees Celsius. Typical lifetime of alkaline electrolyzer stacks is approximately 10 years, and all materials used in such stacks need to withstand exposure to operating conditions for the entire lifetime of the stack. However, for the purpose of screening materials for use in alkaline electrolyzers, an exposure time of 100 hours in 6 M KOH at 80° C. is often sufficient for evaluating material phase stability. Materials which are not phase-stable after exposure to 100 hours of 6 M KOH at 80° C. are not suitable for use as electrode materials.

### BRIEF DESCRIPTION OF DRAWINGS

FIG. 1 shows stability and activity of ceramic materials as function of the stability factor.

### DETAILED DESCRIPTION OF DRAWINGS

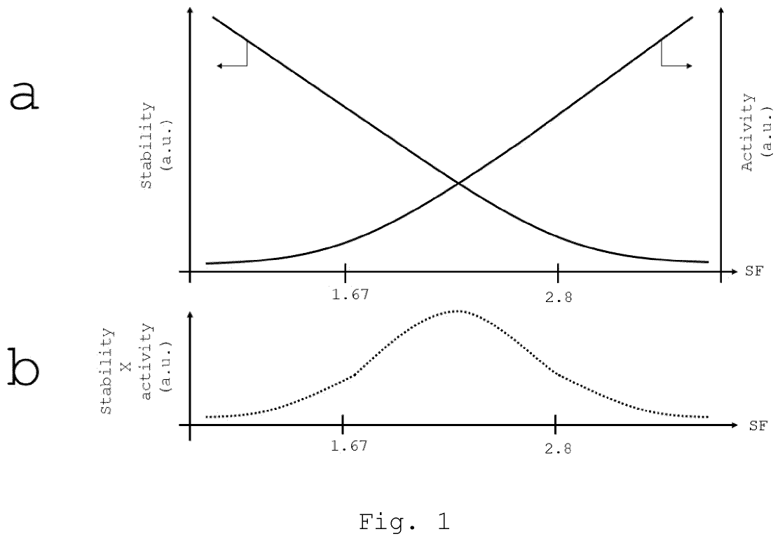

FIG. 1a shows the qualitative relationship (in arbitrary units) between the phase stability on the left vertical axis titled “Stability (a.u)” and the stability factor (“SF”) on the horizontal axis. More specifically, at low SF values, the phase stability of ceramic materials of the formula [(Aₓ) A′₍₁₋ₓ₎]_{y}B_{z}B′_{(1-z)}O_{3-δ} increases, i.e., they are less prone to decomposition and phase change when exposed to electrolysis conditions. At higher SF values, the phase stability of such materials decreases, and at SF>2.8, the materials are no longer phase-stable under industrially relevant electrolysis conditions. Therefore, materials with SF>2.8 are not particularly well suited for use as oxygen electrodes in alkaline electrolysis cells.

Furthermore, FIG. 1a also shows the qualitative relationship (in arbitrary units) between the electrochemical activity on the right vertical axis titled “Activity (a.u)” and the stability factor (“SF”) on the horizontal axis. More specifically, at high SF values, the electrochemical activity of ceramic materials of the formula [(Aₓ)A′₍₁₋ₓ₎]_{y}B_{z}B′_{(1-z)}O_{3-δ} increases, i.e., overpotential towards OER decreases when these materials are exposed to electrolysis conditions. At lower SF values, the activity of such materials decreases, and at SF<1.67, the materials are no longer active enough under industrially relevant electrolysis conditions. Therefore, materials with SF<1.67 are not particularly well suited for use as oxygen electrodes in alkaline electrolysis cells.

FIG. 1b shows the qualitative relationship between a parameter “stability multiplied by activity”, in arbitrary units, on the vertical axis and the stability factor (“SF”) on the horizontal axis. Optimal material properties, i.e., the combination of high stability and high activity, are obtained when 1.67≤SF≤2.8.

### BEST MODE(S) FOR CARRYING OUT THE INVENTION

The method is illustrated in more detail in the non-limiting examples that follow.

### EXAMPLES

### Example 1 (Comparative Example)

In Table 1, a selection of ceramic materials from the barium strontium cobaltite-ferrite family are listed, along with the relevant material properties and SF values. The Shannon ionic radius of Ba²⁺ with a coordination number of 12 is 1.61 Å, while the ionic radius of Sr²⁺ with a coordination number of 9 is 1.31 Å, resulting in r_{A,av}=1.46 Å. The Shannon ionic radius of Co³⁺ with a coordination number of 6 is 0.545 Å and that of Fe³⁺ with a coordination number of 6 is 0.55 Å. The resulting r_{B,av} values are provided in Table 1. The SF value remains almost constant regardless of the Co: Fe ratio for (Ba_{0.5}Sr_{0.5})_{1.0}CO_{z}Fe_{1-z}O_{2.5} materials with y=1. For example, Ba_{0.5}Sr_{0.5}Co_{0.8}Fe_{0.2}O_{2.5} with y=1 has an SF value of 3.50, while the SF value for Ba_{0.5}Sr_{0.5}Co_{0.2}Fe_{0.8}O₃ is 3.49. In other words, regardless of the chosen Co: Fe ratio in (Ba_{0.5}Sr_{0.5})_{1.0}CO_{z}Fe_{1-z}O₃, the material is predicted not to be phase-stable under conditions relevant for industrial alkaline electrolysis. In good agreement with predictions, Ba_{0.5}Sr_{0.5}CO_{0.8}Fe_{0.2}O_{3-δ} has shown not to be stable in 0.1 M KOH.

Materials in Table 1 can be synthesized using methods such as (but not limited to) solid state synthesis, co-precipitation, hydrothermal synthesis, sol-gel synthesis, chemical vapor deposition, spray pyrolysis, atmospheric plasma deposition by mixing the metal precursors in desired ratios and optionally treating the resulting mixture to form the correct crystallographic phase. The same methods can be applied for synthesizing materials described also in the examples that follow.

TABLE 1

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (Ba_{0.5}Sr_{0.5})_{1.0}Co_{0.8}Fe_{0.2}O_{2.5} | 1 | 1.46 | 0.546 | 2 | 0.5 | 1.13 | 3.50 |
| (Ba_{0.5}Sr_{0.5})_{1.0}Co_{0.6} Fe_{0.4}O_{2.5} | 1 | 1.46 | 0.547 | 2 | 0.5 | 1.13 | 3.49 |
| (Ba_{0.5}Sr_{0.5})_{1.0}Co_{0.4} Fe_{0.6}O_{2.5} | 1 | 1.46 | 0.548 | 2 | 0.5 | 1.13 | 3.49 |
| (Ba_{0.5}Sr_{0.5})_{1.0}Co_{0.2} Fe_{0.8}O_{2.5} | 1 | 1.46 | 0.549 | 2 | 0.5 | 1.13 | 3.49 |

### Example 2 (Comparative Example)

In Table 2, a selection of ceramic materials from the barium strontium cobaltite-ferrite family are listed, along with the relevant material properties and SF values. In Table 2, the A-site occupancy of (Ba_{0.5}Sr_{0.5})_{y}CO_{0.8}Fe_{0.2}O_{3-δ} materials is systematically varied in the range 0.7≤y≤1. As the value of y decreases, the value of SF increases, i.e. the material becomes less phase-stable. Regardless of the chosen value of y in (Ba_{0.5}Sr_{0.5})_{y}Co_{0.8}Fe_{0.2}O_{3-δ}, the material is predicted not to be phase-stable under conditions relevant for industrial alkaline electrolysis.

TABLE 2

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (Ba_{0.5}Sr_{0.5})_{1.0}Co_{0.8}Fe_{0.2}O_{2.5} | 1 | 1.46 | 0.546 | 2 | 0.50 | 1.13 | 3.50 |
| (Ba_{0.5}Sr_{0.5})_{0.9}Co_{0.8}Fe_{0.2}O_{2.44} | 0.9 | 1.314 | 0.546 | 1.8 | 0.56 | 1.10 | 3.71 |
| (Ba_{0.5}Sr_{0.5})_{0.8}Co_{0.8}Fe_{0.2}O_{2.37} | 0.8 | 1.168 | 0.546 | 1.6 | 0.63 | 1.07 | 3.90 |
| (Ba_{0.5}Sr_{0.5})_{0.7}Co_{0.8} Fe_{0.2}O_{2.29} | 0.7 | 1.022 | 0.546 | 1.4 | 0.71 | 1.03 | 4.10 |

### Example 3 (Comparative Example)

In Table 3, a selection of ceramic materials from the barium strontium cobaltite-ferrite family are listed, along with the relevant material properties and SF values. In Table 3, the Ba:Sr ratio, x, of (BaₓSr₁₋ₓ)_{1.0}Co_{0.8}Fe_{0.2}O_{2.5} materials is systematically varied in the range 0.1<x<0.9. Regardless of the chosen value of x in (BaₓSr₁₋ₓ)_{1.0}Co_{0.8}Fe_{0.2}O_{2.5}, the material is predicted not to be phase-stable under conditions relevant for industrial alkaline electrolysis.

TABLE 3

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (Ba₀.₉Sr₀.₁)₁.₀Co₀.₈Fe₀.₂O₂.₅ | 1 | 1.58 | 0.546 | 2 | 0.5 | 1.13 | 3.51 |
| (Ba₀.₈Sr₀.₂)₁.₀Co₀.₈Fe₀.₂O₂.₅ | 1 | 1.55 | 0.546 | 2 | 0.5 | 1.13 | 3.50 |
| (Ba₀.₇Sr₀.₃)₁.₀Co₀.₈Fe₀.₂O₂.₅ | 1 | 1.52 | 0.546 | 2 | 0.5 | 1.13 | 3.50 |
| (Ba₀.₆Sr₀.₄)₁.₀Co₀.₈Fe₀.₂O₂.₅ | 1 | 1.49 | 0.546 | 2 | 0.5 | 1.13 | 3.50 |
| (Ba₀.₅Sr₀.₅)₁.₀Co₀.₈Fe₀.₂O₂.₅ | 1 | 1.46 | 0.546 | 2 | 0.5 | 1.13 | 3.50 |
| (Ba₀.₄Sr₀.₆)₁.₀Co₀.₈Fe₀.₂O₂.₅ | 1 | 1.43 | 0.546 | 2 | 0.5 | 1.13 | 3.50 |
| (Ba₀.₃Sr₀.₇)₁.₀Co₀.₈Fe₀.₂O₂.₅ | 1 | 1.4 | 0.546 | 2 | 0.5 | 1.13 | 3.51 |
| (Ba₀.₂Sr₀.₈)₁.₀Co₀.₈Fe₀.₂O₂.₅ | 1 | 1.37 | 0.546 | 2 | 0.5 | 1.13 | 3.52 |
| (Ba₀.₁Sr₀.₉)₁.₀Co₀.₈Fe₀.₂O₂.₅ | 1 | 1.34 | 0.546 | 2 | 0.5 | 1.13 | 3.53 |

### Example 4 (Comparative Example)

In Table 4, a selection of ceramic materials from the family (A_{0.5}Sr_{0.5})_{1.0}Co_{0.8}Fe_{0.2}O₃ are listed, along with the relevant material properties and SF values. In Table 4, one of the A-site cations, A in (A_{0.5}Sr_{0.5})_{1.0}Co_{0.8}Fe_{0.2}O_{3-δ} is systematically varied, with A selected from Ba²⁺, Ce³⁺, Gd³⁺, Pr³⁺, and La³⁺. The Shannon ionic radius of Ba²⁺ with a coordination number of 12 is 1.61 Å, while the ionic radius of Sr²⁺ with a coordination number of 9 is 1.31 Å, resulting in TA, av=1.46 Å for (Ba_{0.5}Sr_{0.5})_{1.0}Co_{0.8}Fe_{0.2}O_{2.5}. The Shannon ionic radius for La³⁺ with a coordination number of 12 is 1.36 Å, resulting in r_{A,av}=1.335 Å for (La_{0.5}Sr_{0.5})_{1.0}Co_{0.8}Fe_{0.2}O_{2.75}. The Shannon ionic radii for Ce³⁺ (12-coordinated), Pr³⁺ (9-coordinated), and Gd³⁺ (8-coordinated) is 1.34 Å, 1.18 Å and 1.05 Å, respectively. The SF values for (Gd_{0.5}Sr_{0.5})_{1.0}CO_{0.8}Fe_{0.2}O_{2.75}, (Pr_{0.5}Sr_{0.5})_{1.0}Co_{0.8}Fe_{0.2}O_{2.75}, (La_{0.5}Sr_{0.5})_{1.0}Co_{0.8}Fe_{0.2}O_{2.75}, and (Ce_{0.5}Sr_{0.5})_{1.0}Co_{0.8}Fe_{0.2}O_{2.75}, are all below 3.1, SF=3.5 while for (Ba_{0.5}Sr_{0.5})_{1.0}Co_{0.8}Fe_{0.2}O_{2.5}. Accordingly, the materials (A_{0.5}Sr_{0.5})_{1.0}Co_{0.8}Fe_{0.2}O_{3-δ}, where A=Ce, Gd, Pr, and La are expected to be more phase-stable than material where A=Ba, but none of the materials are phase-stable enough for use in industrial alkaline electrolyzers.

TABLE 4

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (Ba_{0.5}Sr_{0.5})_{1.0}Co_{0.8}Fe_{0.2}O_{2.5} | 1 | 1.46 | 0.546 | 2 | 0.5 | 1.13 | 3.50 |
| (Gd_{0.5}Sr_{0.5})_{1.0}Co_{0.8}Fe_{0.2}O_{2.75} | 1 | 1.1815 | 0.546 | 2.5 | 0.25 | 1.24 | 3.02 |
| (Pr_{0.5}Sr_{0.5})_{1.0}Co_{0.8}Fe_{0.2}O_{2.75} | 1 | 1.2445 | 0.546 | 2.5 | 0.25 | 1.24 | 2.93 |
| (La_{0.5}Sr_{0.5})_{1.0}Co_{0.8}Fe_{0.2}O_{2.75} | 1 | 1.335 | 0.546 | 2.5 | 0.25 | 1.24 | 2.85 |
| (Ce_{0.5}Sr_{0.5})_{1.0}Co_{0.8}Fe_{0.2}O_{2.75} | 1 | 1.325 | 0.546 | 2.5 | 0.25 | 1.24 | 2.86 |

### Example 5

In Table 5, a selection of ceramic materials from the gadolinium strontium cobaltite-ferrite family are listed, along with the relevant material properties and SF values. In Table 5, the Gd: Sr ratio, x, of (GdₓSr₁₋ₓ)_{0.97}Co_{0.8}Fe_{0.2}O_{3-δ} materials is systematically varied in the range 0.1<x<0.9. In contrast to the comparative example of Example 3, the two A-site cations carry a different positive charge (Gd³⁺, Sr²⁺), which results in better phase stability at high Gd contents: materials where x<0.2 have SF values below 2.8 and are thus predicted to be phase-stable under conditions relevant for industrial alkaline electrolysis. Materials in Table 5 with 0.2≤x≤1 are not phase-stable.

TABLE 5

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (Gd_{0.9}Sr_{0.1})_{0.97}Co_{0.8}Fe_{0.2}O_{2.91} | 0.97 | 1.046 | 0.546 | 2.813 | 0.0935 | 1.31 | 2.77 |
| (Gd₀₈Sr_{0.2})_{0.97}Co_{0.8}Fe_{0.2}O_{2.86} | 0.97 | 1.071 | 0.546 | 2.716 | 0.142 | 1.29 | 2.89 |
| (Gd_{0.7}Sr_{0.3})_{0.97}Co_{0.8}Fe_{0.2}O_{2.81} | 0.97 | 1.096 | 0.546 | 2.619 | 0.1905 | 1.26 | 3.00 |
| (Gd_{0.6}Sr_{0.4})_{0.97}Co_{0.8}Fe_{0.2}O_{2.76} | 0.97 | 1.121 | 0.546 | 2.522 | 0.239 | 1.24 | 3.11 |
| (Gd_{0.5}Sr_{0.5})_{0.97}Co_{0.8}Fe_{0.2}O_{2.71} | 0.97 | 1.146 | 0.546 | 2.425 | 0.2875 | 1.22 | 3.22 |
| (Gd_{0.4}Sr_{0.6})_{0.97}Co_{0.8}Fe_{0.2}O_{2.66} | 0.97 | 1.171 | 0.546 | 2.328 | 0.336 | 1.20 | 3.32 |
| (Gd_{0.3}Sr_{0.7})_{0.97}Co_{0.8}Fe_{0.2}O_{2.62} | 0.97 | 1.196 | 0.546 | 2.231 | 0.3845 | 1.18 | 3.41 |
| (Gd_{0.2}Sr_{0.8} )_{0.97}Co_{0.8}Fe_{0.2}O_{2.57} | 0.97 | 1.221 | 0.546 | 2.134 | 0.433 | 1.16 | 3.49 |
| (Gd_{0.1}Sr_{0.9})_{0.97}Co_{0.8}Fe_{0.2}O_{2.52} | 0.97 | 1.246 | 0.546 | 2.037 | 0.4815 | 1.13 | 3.56 |

### Example 6

In Table 6, a selection of ceramic materials from the family (La_{0.6}A′_{0.4})_{0.99}Co_{0.8}Fe_{0.2}O_{3-δ} are listed, along with the relevant material properties and SF values. The Shannon ionic radius of Ca²⁺ with a coordination number of 12 is 1.34 Å, while the ionic radius of Sr²⁺ with a coordination number of 9 is 1.31 Å. The ionic radius of Ba²⁺ with a coordination number of 12 is 1.61 Å and the ionic radius of Ce³⁺ with a coordination number of 12 is 1.34 Å. In Table 6, one of the A-site cations, A′ in (La_{0.6}A′_{0.4})_{0.99}Co_{0.8}Fe_{0.2}O₃ is systematically varied, with A′ selected from Sr²⁺, Ca²⁺, Ba²⁺ and Ce³⁺. The SF values for all materials in Table 6 are within the range 1.67≤SF≤2.8, but none of the SF values are within the range 1.9≤SF≤2.6.

TABLE 6

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (La0. 6Sr0. 4 )0. 99C00. : Fe0.202. 79 | 0.99 | 1.3266 | 0.546 | 2.574 | 0.213 | 1.25 | 2.72 |
| (La0. 6Ca0. 4 )0. 99C00. 8 Fe0. 202.79 | 0.99 | 1.33848 | 0.546 | 2.574 | 0.213 | 1.25 | 2.71 |
| (La0. 6Ba0.4)0. 99C00. 8 Fe0. 202.79 | 0.99 | 1.4454 | 0.546 | 2.574 | 0.213 | 1.25 | 2.67 |
| (La0. 6Ce0. 4)0.99C00. 8 Fe0. 202.98 | 0.99 | 1.33848 | 0.546 | 2.97 | 0.015 | 1.34 | 1.76 |

### Example 7

In Table 7, a selection of ceramic materials from the family (La_{0.9}Sr_{0.1})_{0.97}BO_{3-δ} are listed, along with the relevant material properties and SF values. In Table 7, the B-site cation, B′ in (La_{0.9}Sr_{0.1})_{0.97}BO_{3-δ} is systematically varied, with B selected from Mn, Ni, Fe, Co, Ti, and Cr. The average oxidation state of Mn, Ni, Fe, Co, and Cr ions is assumed to be 3.1. An exception here is Ti, which is present as Ti⁴⁺ (6-coordinated) with an ionic radius of 0.605 Å, resulting in δ=−0.455. The ionic radius of Co³⁺, Co⁴⁺, Fe³⁺, Fe⁴⁺, Mn³⁺, Mn⁴⁺, Ni³⁺, Ni⁴⁺, Cr³⁺, and Cr⁴⁺ (all with a coordination number of 6) is 0.545 Å, 0.53 Å, 0.55 Å, 0.585 Å, 0.58 Å, 0.53 Å, 0.56 Å, 0.48 Å, 0.615 Å, 0.55 Å, respectively. For all materials in Table 7, 1.67≤SF≤2.8.

TABLE 7

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (La₀.₉Sr₀.₁)₀.₉₇CoO₂.₉₆ | 0.97 | 1.31435 | 0.5435 | 2.813 | 0.0435 | 1.33 | 2.24 |
| (La₀.₉₁Sr₀.₁)₀.₉₇FeO₂.₉₆ | 0.97 | 1.31435 | 0.5535 | 2.813 | 0.0435 | 1.33 | 2.21 |
| (La₀.₉Sr₀.₁)₀.₉₇MnO₂.₉₆ | 0.97 | 1.31435 | 0.575 | 2.813 | 0.0435 | 1.33 | 2.18 |
| (La₀.₉Sr₀.₁)₀.₉₇TiO₃.₄₁ | 0.97 | 1.31435 | 0.605 | 2.813 | -0.407 | 1.53 | 2.50 |
| (La₀.₉Sr₀.₁)₀.₉₇NiO₂.₉₆ | 0.97 | 1.31435 | 0.552 | 2.813 | 0.0435 | 1.33 | 2.22 |
| (La₀.₉Sr₀.₁)₀.₉₇CrO₂.₉₆ | 0.97 | 1.31435 | 0.6085 | 2.813 | 0.0435 | 1.33 | 2.16 |

### Example 8

In Table 8, a selection of ceramic materials from the family (La_{0.9}Sr_{0.1})_{y}BO_{3+δ} are listed, along with the relevant material properties and SF values. In Table 8, the B-site cation, B′ in (La_{0.9}Sr_{0.1})_{y}BO_{3+δ} is systematically varied, with B selected from Mn, Ni, Fe, Co, Ti, and Cr and 0.65<y<0.95. The average charge of Mn, Ni, Fe, Co, and Cr ions is assumed to be 3.1, while Ti is assumed to be present as Ti⁴⁺. Comparing SF values in Table 8 to SF values in Table 7, it is apparent that decreasing the A-site occupancy of ceramic materials systematically increases the SF values, i.e., by varying y, the activity as well as phase stability of the materials can be tailored. Some materials, such as (La_{0.9}Sr_{0.1})_{0.90}TiO_{3.31}, (La_{0.9}Sr_{0.1})_{0.8}TiO_{3.16}, (La_{0.9}Sr_{0.1})_{0.65}TiO_{2.94}, and (La_{0.9}Sr_{0.1})_{0.90}CrO_{2.86} become too unstable (SF>2.8), while others, such remain phase-stable (1.67≤SF≤2.8).

TABLE 8

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| (La_{0.9}Sr_{0.1})_{0.95}CoO_{2.93} | 0.95 | 1.28725 | 0.5435 | 2.755 | 0.0725 | 1.32 | 2.40 |
| (La_{0.9}Sr₀.₁)_{0.90}CoO_{2.86} | 0.9 | 1.2195 | 0.5435 | 2.61 | 0.145 | 1.28 | 2.80 |
| (La_{0.9}Sr_{0.1})_{0.95}FeO_{2.93} | 0.95 | 1.28725 | 0.5535 | 2.755 | 0.0725 | 1.32 | 2.38 |
| (La_{0.9}Sr_{0.1})_{0.90}FeO_{2.86} | 0.9 | 1.2195 | 0.5535 | 2.61 | 0.145 | 1.28 | 2.79 |
| (La_{0.9}Sr_{0.1})_{0.95}MnO₂ ₉₃ | 0.95 | 1.28725 | 0.575 | 2.755 | 0.0725 | 1.32 | 2.35 |
| (La_{0.9}Sr_{0.1})_{0.90}MnO_{2.86} | 0.9 | 1.2195 | 0.575 | 2.61 | 0.145 | 1.28 | 2.78 |
| (La_{0.9}Sr_{0.1})_{0.95}TiO_{3.38} | 0.95 | 1.28725 | 0.605 | 2.755 | −0.378 | 1.52 | 2.69 |
| (La_{0.9}Sr_{0.1})_{0.90}TiO_{3.31} | 0.9 | 1.2195 | 0.605 | 2.61 | −0.305 | 1.49 | 3.15 |
| (La_{0.9}Sr_{0.1})_{0.80}TiO_{3.16} | 0.8 | 1.084 | 0.605 | 2.32 | −0.16 | 1.42 | 4.10 |
| (La_{0.9}Sr_{0.1})_{0.65}TiO_{2.94} | 0.65 | 0.88075 | 0.605 | 1.885 | 0.0575 | 1.32 | 5.94 |
| (La_{0.9}Sr_{0.1})_{0.95}NiO_{2.93} | 0.95 | 1.28725 | 0.552 | 2.755 | 0.0725 | 1.32 | 2.38 |
| (La_{0.9}Sr_{0.1})_{0.90}NiO_{2.86} | 0.9 | 1.2195 | 0.552 | 2.61 | 0.145 | 1.28 | 2.79 |
| (La_{0.9}Sr_{0.1})_{0.95}CrO_{2.93} | 0.95 | 1.28725 | 0.6085 | 2.755 | 0.0725 | 1.32 | 2.35 |
| (La_{0.9}Sr_{0.1})_{0.90}CrO_{2.86} | 0.9 | 1.2195 | 0.6085 | 2.61 | 0.145 | 1.28 | 2.82 |

### Example 9

In Table 9, a selection of ceramic materials from the lanthanum nickelate-ferrite family are listed, along with the relevant material properties and SF values. For example, LaNi_{0.6}Fe_{0.4}O₃ with y=1 has an SF value of 1.63, while La_{0.95}Ni_{0.6}Fe_{0.4}O_{2.925} with y=0.95 has an SF value of 2.10. The SF value for La_{0.90}Ni_{0.6}Fe_{0.4}O_{2.85} is 2.55, and the SF values for materials in Table 9 with y≤0.85 are above 2.8. LaNi_{0.6}Fe_{0.4}O₃ (y=1) is phase-stable when exposed to 6 M KOH at 80° C., whereas materials in Table 9 with y≤0.85 are not. For the more extreme cases, e.g., La_{0.5}Ni_{0.6}Fe_{0.4}O_{2.25}, the ceramic material does not form the perovskite structure and a multi-phase and multi-component material is present even before exposure to industrial alkaline electrolysis conditions. In the other extreme, LaNi_{0.6}Fe_{0.4}O₃ with y=1 with an SF value of 1.63 is not active enough towards the oxygen evolution reaction based on the very low SF value.

TABLE 9

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| LaNi₀.₆Fe_{0.4}O₃ | 1 | 1.36 | 0.556 | 3 | 0 | 1.35 | 1.63 |
| La_{0.95}Ni_{0.6}Fe_{0.4}O_{2.925} | 0.95 | 1.292 | 0.556 | 2.85 | 0.075 | 1.32 | 2.10 |
| La_{0.90}Ni_{0.6}Fe_{0.4}O_{2.85} | 0.9 | 1.224 | 0.556 | 2.7 | 0.15 | 1.28 | 2.55 |
| La_{0.85}Ni_{0.6}Fe_{0.4}O_{2.775} | 0.85 | 1.156 | 0.556 | 2.55 | 0.225 | 1.25 | 2.99 |
| La_{0.80}Ni_{0.6}Fe_{0.4}O_{2.7} | 0.8 | 1.088 | 0.556 | 2.4 | 0.3 | 1.22 | 3.42 |
| La_{0.75}Ni_{0.6}Fe_{0.4}O_{2.625} | 0.75 | 1.02 | 0.556 | 2.25 | 0.375 | 1.18 | 3.86 |
| La_{0.70}Ni_{0.6}Fe_{0.4}O_{2.55} | 0.7 | 0.952 | 0.556 | 2.1 | 0.45 | 1.15 | 4.34 |
| La_{0.65}Ni_{0.6}Fe_{0.4}O_{2.475} | 0.65 | 0.884 | 0.556 | 1.95 | 0.525 | 1.11 | 4.89 |
| La_{0.60}Ni_{0.6}Fe_{0.4}O_{2.4} | 0.6 | 0.816 | 0.556 | 1.8 | 0.6 | 1.08 | 5.59 |
| La_{0.55}N_{0.6}Fe_{0.4}O_{2.325} | 0.55 | 0.748 | 0.556 | 1.65 | 0.675 | 1.05 | 6.64 |
| La_{0.5}Ni_{0.6}Fe_{0.4}O_{2.25} | 0.5 | 0.68 | 0.556 | 1.5 | 0.75 | 1.01 | 8.68 |

### Example 10

La_{0.95}CoO_{2.925}, Pr_{0.95}CoO_{2.925}, Gd_{0.95}CoO_{2.925}, (La_{0.9}Sr_{0.1})_{0.95}CoO_{2.878}, La_{0.95}NiO_{2.925}, LaFeO_{2.925}, La_{0.95}Ni_{0.6}Co_{0.4}O_{2.925}, and La_{0.95}Ni_{0.6}Fe_{0.4}O_{2.925} were synthesized using a modified sol-gel synthesis route. The resulting materials were calcined to 800° C. for 3 hours to obtain oxide catalyst materials with perovskite structure as verified by X-ray diffraction measurements. The material properties and SF values are summarized in Table 10.

TABLE 10

| | | | | | | r₀(3- | |
|---|---|---|---|---|---|---|---|
| Ceramic material | y | r_{A, av}/Å | r_{B, av}/Å | n_{A, AV} | δ | δ)/3 | SF |
| Gd_{0.95}CoO_{2.925} | 0.95 | 1.000 | 0.545 | 2.85 | 0.075 | 1.32 | 2.91 |
| La_{0.95}Ni_{0.6}Fe_{0.4}O_{2.925} | 0.95 | 1.292 | 0.556 | 2.85 | 0.075 | 1.32 | 2.10 |
| LaFeO₃ | 0.95 | 1.36 | 0.55 | 3 | 0 | 1.35 | 1.65 |

The calcined materials were characterized electrochemically in a rotating disk electrode (RDE) setup. For these measurements, each perovskite material was mixed with Nafion solution, isopropanol and ultrapure water to obtain a slurry. The slurry was coated onto glassy carbon electrodes at a loading of 0.2 mg/cm². The electrodes were tested in a three-electrode setup in 0.1 M KOH saturated with argon. OER kinetics were evaluated by applying a linearly changing potential to the electrode and measuring the resulting current. The potential was swept from 1.3 V to 1.9 V and back to 1.3 V vs RHE. The electrode was rotated at 1500 rpm, and the measurements were carried out at room temperature.

Furthermore, the materials were subjected to a strong alkali treatment to evaluate phase stability. Each material was treated in 6 M KOH for 100-120 hours at a temperature of 80 degrees C. After the treatment, the material was rinsed thoroughly with distilled water, dried and the crystallographic structure of the materials was studied with x-ray diffraction (XRD).

Specifically, the calcined Gd_{0.95}CoO_{2.925} material was found to consist primarily of a perovskite material, with the main XRD peaks (in the order of decreasing intensity) at 33.86°, 34.36°, and 33.20° 2-theta. The calcined material was highly active electrochemically: the potential required to reach an OER current of 10 mA/cm² was 1.67 V. As expected from the high SF value (SF>2.8), the material proved not to be phase stable after the treatment in 6M KOH. The main XRD peaks had changed to (in the order of decreasing intensity) 28.19°, 50.70°, 41.25°, and 29.52° 2-theta, indicating that the original perovskite material had decomposed. The KOH-treated material was found to be significantly less active in RDE measurements (1.73 V to reach OER current of 10 mA/cm²). Gd_{0.95}CoO_{2.925} is an example of a material that is initially electrochemically very active, but insufficiently phase-stable in industrially relevant alkaline electrolysis conditions.

The calcined La_{0.95}Ni_{0.6}Fe_{0.4}O_{2.925} material was found to consist primarily of a perovskite material, with the main XRD peaks (in the order of decreasing intensity) at 32.56°, 32.84°, and 46.94° 2-theta. The calcined material was active electrochemically: the potential required to reach an OER current of 10 mA/cm² was 1.66 V. As expected from the SF value (1.67≤SF≤2.8), the material proved to be phase stable after the treatment in 6M KOH. The main XRD peaks did not change: (in the order of decreasing intensity) 32.60°, 32.80°, and 46.98° 2-theta, indicating that the original perovskite material remained stable under treatment conditions. The KOH-treated material was found to be somewhat less active in RDE measurements, but the activity was withing acceptable limits (1.72 V to reach OER current of 10 mA/cm²). La_{0.95}Ni_{0.6}Fe_{0.4}O_{2.925} is an example of a material that offers good compromise between electrochemical activity and sufficient phase-stability in industrially relevant alkaline electrolysis conditions.

The calcined LaFeO₃ material was found to consist primarily of a perovskite material, with the main XRD peaks (in the order of decreasing intensity) at 33.16°, 57.40°, and 46.16° 2-theta. The calcined material was highly inactive electrochemically: the material did not reach an OER current of 10 mA/cm² when the potential was increased to 1.9 V, with the current density at 1.9 V being equal to only 3.5 mA/cm². As expected from the low SF value (SF<1.67), the material proved to be phase stable after the treatment in 6M KOH. The main XRD peaks did not change, indicating that the original perovskite material had decomposed. LaFeO₃ is an example of a material that is highly stable, but insufficiently active for OER in industrially relevant alkaline electrolysis conditions.

An electrode suitable for carrying out oxygen evolution reaction in the electrolysis of water in alkaline conditions can be designed according to the following steps:
1) Pre-select a ceramic material with a formula [(Aₓ)A′₍₁₋ₓ₎]_{y}B_{z}B′_{(1-z)}O_{3-δ}, for example LaNi_{0.6}Fe_{0.4}O₃.
2) Based on the ionic radii, oxidation state values, A-site occupancy (y), oxygen non-stoichiometry (d), and A- and B-site doping levels (x and z, respectively), and using the formula for the calculation of SF, estimate the value of SF. For example, SF for LaNi_{0.6}Fe_{0.4}O₃ is 1.63.
3) If SF is within suitable range (1.67<SF≤2.8), synthesize the material according to the methods listed (but not limited to) in Example 1 and select the ceramic material for further testing, for example by exposing the material for 100 hours to 6 M KOH at 80 degrees Celsius to verify phase-stability. For example, LaNi_{0.6}Fe_{0.4}O₃ would not be selected for further testing due to SF<1.67.
4) In case SF is outside the suitable range, vary the value for y within the range 0.5 to 0.99, and preferably within the range 0.6 to 0.98 to change the SF value. For example, by altering the value of y from 1.0 to 0.95 (from LaNi_{0.6}Fe_{0.4}O₃ to La_{0.95}Ni_{0.6}Fe_{0.4}O_{2.925}), the SF value can be increased to 2.1, thereby satisfying the condition of 1.67≤ SF≤2.8.
5) Alternatively to step 4, SF value can be altered by varying the value for x and/or z. For example, by altering the value of z from 0.6 to 0.1 (from LaNi_{0.6}Fe_{0.4}O₃ to LaNi_{0.1}Fe_{0.9}O₃), the SF value can be increased from 1.63 to 1.65.
6) Alternatively to steps 4 or 5, SF value can be altered by varying the elemental composition of the ceramic material. For example, by replacing Fe with Co, i.e., changing the composition of the material from LaNi_{0.6}Fe_{0.4}O₃ to LaNi_{0.6}Co_{0.4}O₃, the SF value can be increased from 1.63 to 1.64.

7) Steps 4, 5, and 6 can be advantageously combined. For example, the SF value of LaNi_{0.6}Co_{0.4}O₃ can be increased from 1.64 to 2.04 by decreasing y from 1 to 0.95, i.e., La_{0.95}Ni_{0.6}Co_{0.4}O_{2.85}, thereby satisfying the condition of 1.67≤SF≤2.8.

1. An electrode suitable for carrying out oxygen evolution reaction in the electrolysis of water in alkaline conditions, the electrode comprising a ceramic material of formula (I)
$${[ ( {A}_{x} ) {A}_{( 1 - x )}^{′} ]}_{y} {B}_{z} {B}_{( 1 - z )}^{′} {O}_{3 - δ} \qquad ( I )$$
where each of A and A′, independently, is a rare earth or alkaline earth metal, x is in the range of 0 to 1, y is A-site occupancy and is in the range of 0.5 to 0.99, each of B and B′, independently, is a transition metal, z is in the range of 0 to 1, O is oxygen, and 8 is oxygen non-stoichiometry and is in the range of −1 to 1; and
a second material, this second material being metallic Ni, a metallic alloy of Fe and Ni, or a hydroxide of Ni and Fe:
where stability factor (SF) of the ceramic material is defined in formula (II),
$$SF = \frac{\text{?}}{{r}_{B , av}} - {n}_{A , Av} [ {n}_{A , Av} - \frac{{r}_{A , av} / {r}_{B , av}}{ln ( \frac{\text{?}}{{r}_{B , av}} )} ] \qquad ( II )$$
$$\text{?} \text{indicates text missing or illegible when filed}$$
where rₒ is the Shannon ionic radius of oxide ion (O²⁻), r_{B,av} is the weighted average Shannon ionic radius of B and B′, defined in formula (III),
$${r}_{B , Av} = z \cdot {r}_{B} + ( 1 - z ) \cdot \text{?} \qquad ( III )$$
$$\text{?} \text{indicates text missing or illegible when filed}$$
where r_{B} is the Shannon ionic radius of B and r_{B′} is the ionic radius of B′, N_{A,Av} is the weighted average oxidation state of A and A′, defined in formula (IV),
$${n}_{A , Av} = [ x \cdot {n}_{A} + ( 1 - x ) \cdot {n}_{{A}^{′}} ] \cdot y , \qquad ( IV )$$
where n_{A} is the oxidation state of A and n_{A′} is the oxidation state of A′, r_{A,av} is the weighted average ionic radius of A and A′, defined in formula (V),
$${r}_{A , Av} = [ x \cdot {r}_{A} + ( 1 - x ) \cdot {r}_{{A}^{′}} ] \cdot y , \qquad ( V )$$
where r_{A} is the Shannon ionic radius of A and r_{A′} is the ionic radius of A′,
wherein the ceramic material includes 1.67≤SF≤2.8.

2. (canceled)

3. The electrode according to claim 21, wherein the ceramic material of formula (I) is uniformly dispersed on the surface of the second material.

4. The electrode according to claim 21, wherein the particles of the ceramic material are immobilized and partly encapsulated by the second material.

5. The electrode according to claim 1, wherein A is an element from the following list of elements: La, Ce, Gd, Pr, Ba; and wherein A′ is an element from the following list of elements: Sr, Ca, Ba, Ce; and wherein B or B′, independently, is an element from the following list of elements: Mn, Ni, Fe, Co, Ti, Cr.

6. The electrode according to claim 1, wherein y is in the range of 0.6 to 0.98.

7. The electrode according to claim 1, wherein the average particle size of the ceramic material of formula (I) is between 10 nm and 300 nm.

8. The electrode according to claim 1, wherein the ceramic material of formula (I) has a perovskite crystal structure.

9. The electrode according to claim 1, wherein the electrode overpotential towards oxygen evolution reaction is less than or equal to 400 millivolts at a current density of 1 mA/cm², when the oxygen evolution reaction is carried out using a rotating disk electrode at a rotation rate of 1500 rpm in 20-35 weight % KOH and at a temperature of 75-85 degrees Celsius.

10. The electrode according to claim 1, wherein the ceramic material of formula (I) is phase-stable for 100 hours in 6 M KOH at 80 degrees Celsius.

11. The electrode according to claim 1, where 1.9≤SF≤2.6.

12. An alkaline electrolysis stack comprising at least one electrode according to claim 1.

13. A method for the electrolysis of water in alkaline conditions using the alkaline electrolysis stack according to claim 12.
